(19) United States
(12) Patent Application Publication
(10) Pub. No.: US 2013/0186381 A1
(43) Pub. Date: Jul. 25, 2013

(54) Pet Ball Launcher With Tuned Scoop Fingers

(71) Applicant: Kyle Hansen, Castle Rock, CO (US)

(72) Inventor: Kyle Hansen, Castle Rock, CO (US)

(73) Assignee: The Kyjen Company, Inc.

(21) Appl. No.: 13/355,517

(22) Filed: Jan. 21, 2012

(51) Int. Cl. A63B 65/12

(52) U.S. Cl. 124/5

(57) ABSTRACT

The invention relates to a novel pet ball launcher which uses a friction fit, scoop edges, and tuned tines or “fingers” which control the release of the ball and thus arc and distance thereof.

### FIELD

The invention relates to a novel pet toy wherein a molded ball launcher uses a friction-fit fulcrum method and scoop extensions with tuned “fingers”, or extended tines, to grip and throw a ball.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel ball launcher which uses a friction fit, scoop edges, and tuned tines or “fingers” which control the release of the ball and thus arc and distance thereof.

The inventive launcher is constructed in plastic with an elliptical cross section so that the launcher may be pressured without breaking such as when a pet owner places the launcher in a car and has other items on top or pressing upon, the launcher. The launcher will not snap or break easily.

### THE INVENTION

### Summary, Objects and Advantages

The handle of the launcher is molded to contain an s-curve. Such shape aids in the function as a fulcrum effect which transfers an appropriate amount of energy to the scoop portion so as to launch a body, herein a ball, in an efficient manner, and with exaggerated distance.

The launcher handle tapers in thickness towards the scoop, or cup, portion which assists in the energy transfer and subsequent launching of the ball as tension and compression work in conjunction with the flexibility of the launcher handle.

The cradling portion of the launcher holds the ball to be launched in conjunction with molded tines or “fingers” which extend to hold the ball until optimum release point. The scoop extensions guide the ball through its release point. The fingers or tines extend and wrap slightly around the ball holding it initially via a friction-fit setting towards its center of gravity and the ball is released upon launching action.

The cup portion contains fore and aft scoop extensions which hold and guide the ball in conjunction with the tuned fingers. If, upon launching mode, the ball is released too early, the ball will exhibit too much arc and thus soar high as opposed to achieving distance. The scoop edges and the tuned fingers control the resting and motion actions of the ball so as to be timed for release at the optimum moment, which should be the inertia point roughly overhead of the user and more parallel to the targeted launch area.

The tuned fingers extend slightly more inward than the top edges of the fore and aft scoop extensions and serve to hold the ball until release point whereupon the scoop extensions serve to guide the flight of the ball. Finally, an ergonomic handle is piece-molded onto the end of the launcher shaft.

In summary, the inventive launcher is simple, yet scientifically designed to achieve optimum performance when launching a ball therefrom.

### BRIEF DESCRIPTION OF THE DRAWINGS

The invention is described in further detail by reference to the drawings in which:

FIG. 1; is a side view of the launcher showing a ball in the scoop, scoop extensions, and the tuned fingers at the scoop center;

FIG. 2; is an angled cross-sectional view of the launcher showing a ball at rest in the cup or scoop portion;

FIG. 3; is a rear section view of the scoop or cup and handle connection point; and

FIG. 4 is a side view of the entire launcher.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in four relatively simple figures; although sufficiently complex as to illuminate to one skilled in the art of such manufacturing and design, a viable method for making or using said invention.

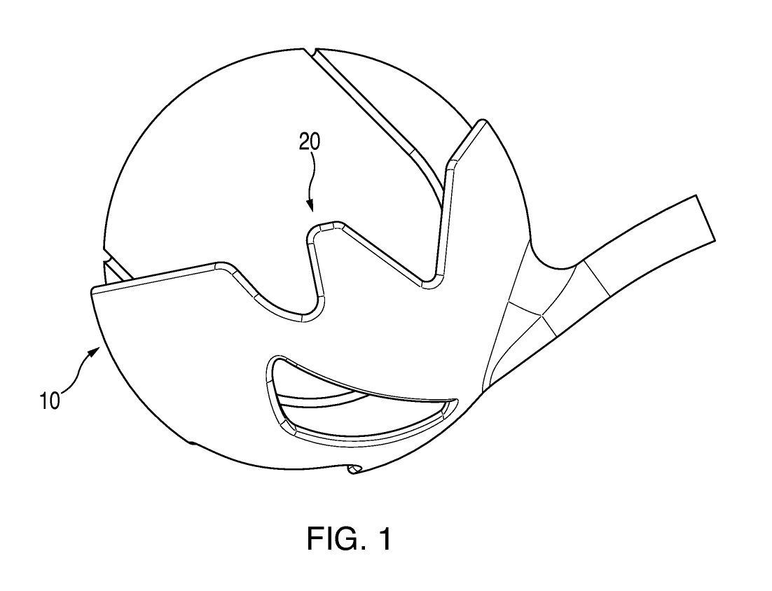

FIG. 1 is side view of the scoop or cup portion 10 of the launcher. A tennis ball is shown cradled in the scoop portion 20. The tuned finger extrusions 30 are illustrated as they will loosely grip the ball more than the illustrated 40 scoop fore and aft extensions. Responding to friction and exposed to inertia, the extensions 40 will assist in guiding the direction of flight of the ball, while the fingers 30 are continuing to slightly grip the ball until the optimum point of release.

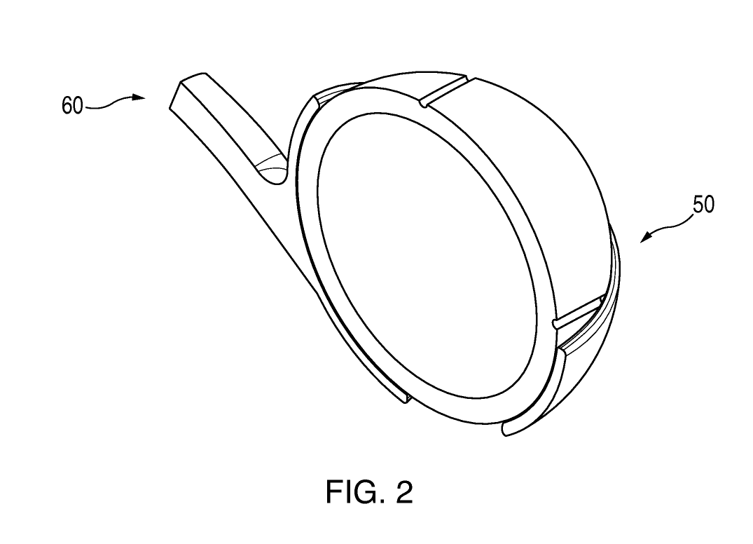

FIG. 2 is a simple side angle cross-sectional view of the scoop 50 and handle 60 portions illustrating a clear example of the ball resting in the cup portion of the launcher.

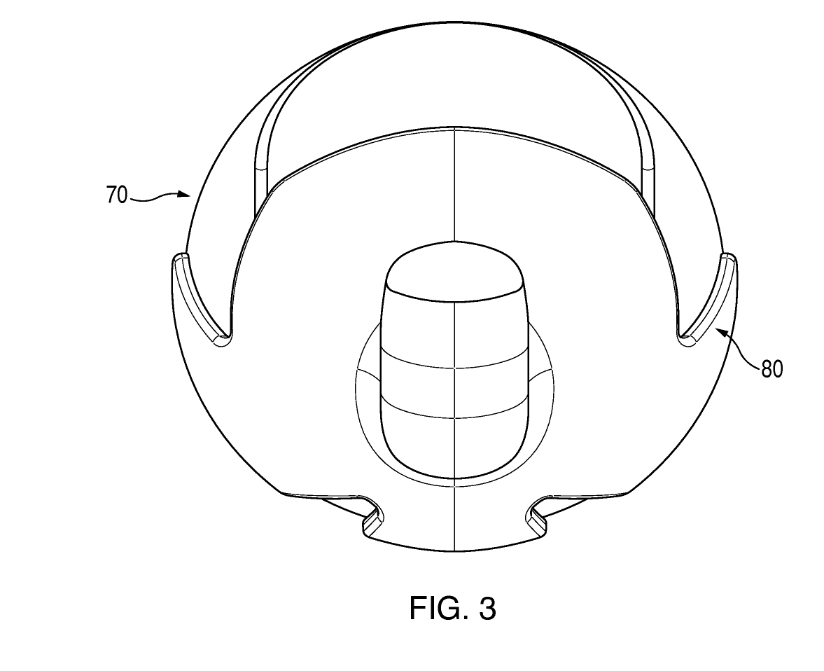

FIG. 3 is a rear angle view to illustrate the general height differential of a resting ball 70 within and above the scoop and the scoop extensions 80.

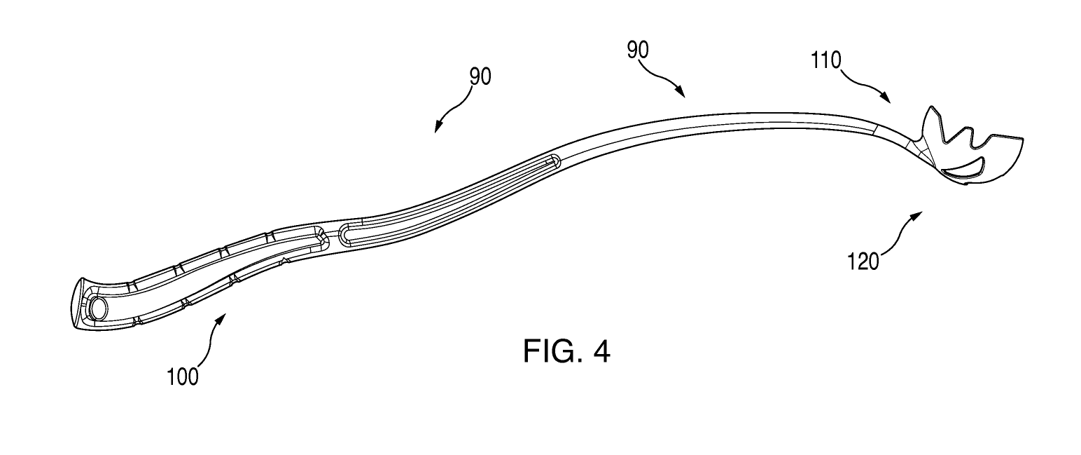

FIG. 4 is a side view of the entire launcher. The angle of the handle 90 assists in the fulcrum action of the launcher, which action transfers an appropriate amount of energy to the scoop portion so as to launch the body, herein the ball, in an efficient manner, and with exaggerated distance. A comfortable ergonomic handle 100 is piece-molded onto the launcher. The handle tapers 110 towards the scoop or cup portion 120 of the launcher. Such tapering aids in the energy transfer and subsequent launching of the ball as tension and compression work in conjunction with the flexibility of the launcher handle.

1) A pet ball launcher comprising:
a) a tapered handle with grip
b) tuned fingers on the scoop portion
c) scoop portion with extensions

2) The pet ball launcher of claim 1 wherein the tapered handle is an s-shape.

3) The pet ball launcher of claim 1 wherein said handle has an ergonomic grip at one end.

4) The pet ball launcher of claim 1 wherein the tuned fingers are extensions of the launcher's scoop portion and hold a ball in place with a slight gripping action.

5) The pet ball launcher of claim 1 wherein the scoop portion of the launcher has extensions fore and aft as originated from the handle perspective and serve to guide the ball upon launch.
